(19) United States
(12) Patent Application Publication
(10) Pub. No.: US 2009/0294350 A1
(43) Pub. Date: Dec. 3, 2009

(54) REPLACEABLE CARTRIDGE TYPE FILTER FOR FILTERING SYSTEMS AND A FILTERING SYSTEM INCORPORATING THE FILTER

(75) Inventor: Maurizio MORETTO, Vicenza (IT)

Correspondence Address: CASTELLANO PLLC, P.O. Box 1555, Great Falls, VA, 22066, US

(73) Assignee: LAICA S.p.A

(21) Appl. No.: 12/471,590

(22) Filed: May 26, 2009

(30) Foreign Application Priority Data
May 27, 2008 (IT) PD2008A000152

(51) Int. Cl. B01D 27/08

(52) U.S. Cl. 210/450

(57) ABSTRACT

A replaceable cartridge type filter for filtering systems for processing drinking water includes a casing for containing the filtering material which extends externally from an annular edge which defines a sealing surface, which is provided so as to engage in a sealing manner with a corresponding seat for receiving and retaining the cartridge so as to identify an upstream portion and a downstream portion of the cartridge which communicate with each other only by way of the cartridge. At the annular edge the filter comprises a deformable seal, whose deformability under load is substantially greater than the deformability of the edge.

### CLAIM FOR PRIORITY

This application claims priority to Italian application PD2008A000152 filed May 27, 2008, the contents of which are incorporated herein by reference.

### FIELD

The present invention relates to a replaceable cartridge type filter for filtering systems, particularly for processing drinking water, and a filtering system including the cartridge type filter.

### BACKGROUND

In the relevant art, it is known to use filtering systems for processing water for domestic use, in which a replaceable cartridge type filter is introduced in a sealing manner into a pipe of the filtering system in such a manner that the water passing through the pipe is forced to travel through the filter and the bed of filtering material contained therein. The filter is normally fitted in a seat by means of an external annular edge thereof which defines a sealing surface which is in turn received with hydraulic sealing and maintained in the above-mentioned seat. With this system for producing jugs and kettles which are provided for processing involving filtering and purifying water for domestic use.

No matter how precisely both the edge of the casing and the relevant fitting seat are processed, it is possible, if not actually commonplace, for the efficacy of the sealing between the seat and the edge of the filter to be potentially unstable. This is both because replacement filters from a specific manufacturer are often fitted in filtering systems from other manufacturers, with resultant geometric inaccuracy in the connection zones between the filter and seat, and because the filters and the jugs are generally produced by moulding from plastics material, with the result that it is probable that, following deformations, contractions, etc., the sealing surfaces do not completely engage with each other.

### SUMMARY

In seeking to adapt the filter to jugs of different types, it is evident that the geometry of the annular edge and the relevant sealing surface would have to be configured so as to be able to adapt to smaller seats among the various filtering systems for which the filter is intended.

A main object of the invention is to provide a replaceable cartridge type filter which is particularly intended for the uses set out above and which is functionally and structurally configured so as to overcome all the disadvantages set out with reference to the art cited. Within the context of the main object, another object of the invention is to provide a cartridge type filter which is universally adaptable to jugs which are of a similar type but from different manufacturers.

Another object of the invention is to provide a filtering system and relevant filter which are highly adaptable with respect to each other.

These objects and other objects which will be set out more clearly below are achieved by a cartridge type filter and a filtering system which are constructed in accordance with the appended claims.

### BRIEF DESCRIPTION OF THE DRAWINGS

The features and advantages of the invention will be better understood from the following detailed description of some preferred, non-exclusive embodiments which are illustrated purely by way of non-limiting example with reference to the appended drawings, in which:

FIG. 1 is a side view of a filtering system comprising a cartridge type filter according to the present invention;

FIG. 2 is a cross-section of a component of the filter of FIG. 1;

FIGS. 3a-e are cross-sections of construction variants of the detail indicated 111 in FIG. 2;

FIG. 4 is a cross-section of a construction variant of the filter of FIG. 1; and

FIG. 5 is a cross-section of the detail indicated V in FIG. 4.

### DETAILED DESCRIPTION

In the Figures, a replaceable cartridge type filter which is constructed in accordance with the present invention is generally designated 1. A filtering system is generally designated 2 and is embodied by a jug for purifying water for domestic use, but could also comprise a kettle, a tisane-maker, a machine for preparing coffee or other beverages, and the like. The filter 1 is provided so as to be fitted in a pipe 3 which connects an upper vessel 4 to a lower vessel 5 of the jug so that all the water which, owing to gravity, is caused to pass from the upper vessel to the lower vessel is obliged to travel through the filter 1.

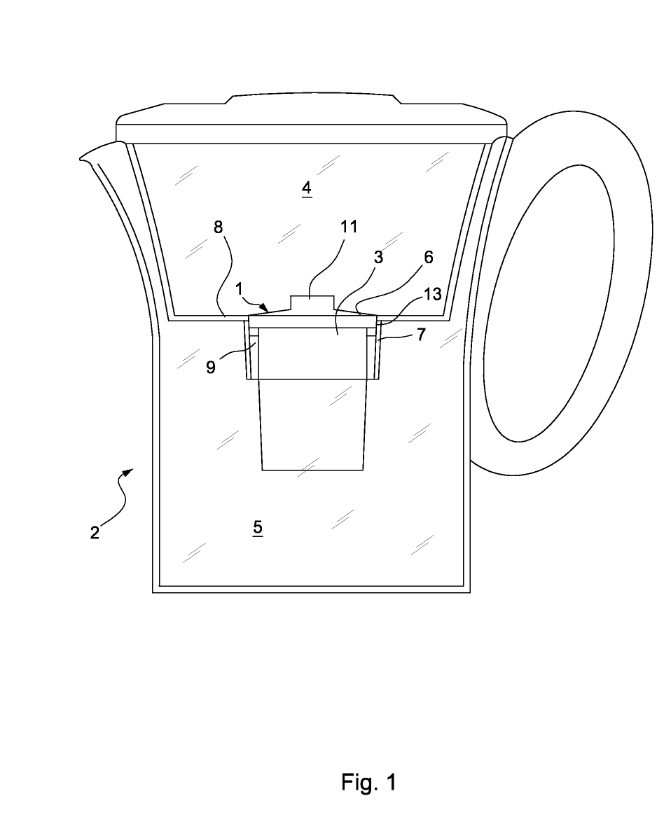

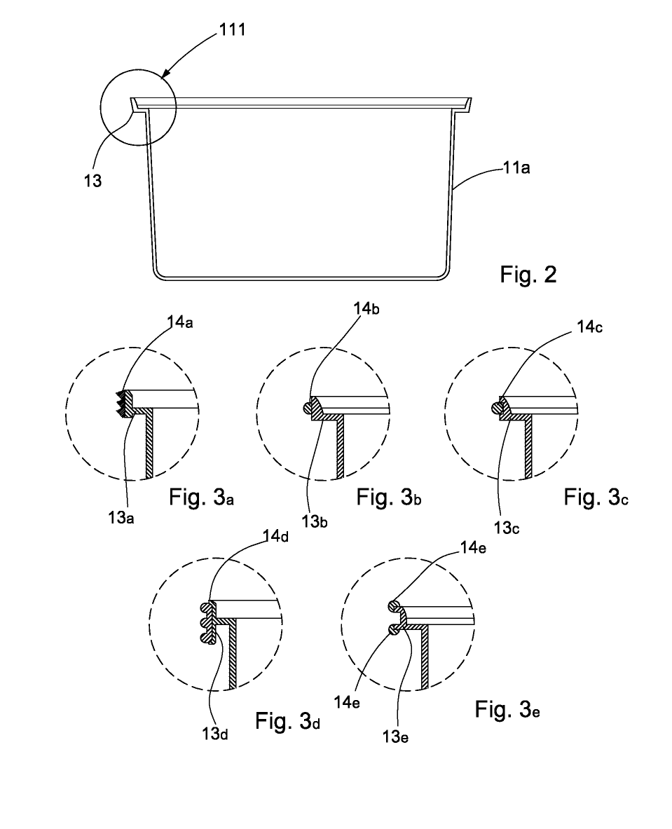

In order to fit the filter 1, there is formed in the pipe 3 a seat 6 having a side wall 7 and a shoulder 8 which extend axially and radially relative to the pipe, respectively. The side wall 7 may have, in a provided configuration thereof (FIG. 1), a plurality of axially extending rib structures 9.

The filter 1 comprises a casing 11, which contains a filtering bed, for example, a mixture of active carbon and ion exchange resin, whose composition is selected in accordance with the type of filtration desired. The casing 11 comprises a bowl 11a and a lid 11b which are both provided with holes for the passage of the water to be filtered.

At the junction zone between the lid and the bowl, there is formed an external annular edge 13 which is received in the seat 6 when the filter 1 is fitted in the pipe 3 in order to hold the filter in a sealing manner in the pipe so that the pipe portions upstream and downstream of the cartridge communicate with each other only by way of the cartridge, respectively.

The FIGS. 3a to 3e illustrate five examples of different geometries for that edge, wherein the edge is indicated by the reference numeral 13, with the addition of a variable index from a to e. In all cases, the edge 13a-e is constructed on the bowl 11a and is provided with a deformable seal 14a-e, whose deformability under load is substantially greater than the deformability of the edge under an equal load. Typically, the edge 13a-e is constructed from a plastics material such as polypropylene. The corresponding seal 14a-e can instead be constructed from natural or synthetic rubber.

In all cases, the seal is preferably jointly produced by co-moulding so as to fix it closely to the edge 13.

In FIG. 3a, the edge 13a has a sealing surface which is substantially planar and the seal 14a is of the type having multiple lips.

In FIG. 3b, the seal 14b has a planar face at the connection side with respect to the sealing surface and has a rounded cross-section at the opposite side.

In FIG. 3c, the edge 13c has a sealing surface which has an annular recess, in which there is partially received the seal 14c which further has a rounded profile which is similar to the one in the preceding example.

In FIG. 3d, the edge 13d has a planar sealing surface which has a wide and shallow groove, in which there is partially received the seal 14d having multiple lips with a rounded profile.

In FIG. 3e, the edge 13e has a planar sealing surface which has a wide and shallow groove, similarly to the preceding case, but with the difference therefrom that two seals 14e are applied, again in this case by means of joint injection-moulding (co-moulding), to the tops separated by the groove instead of the bottom thereof.

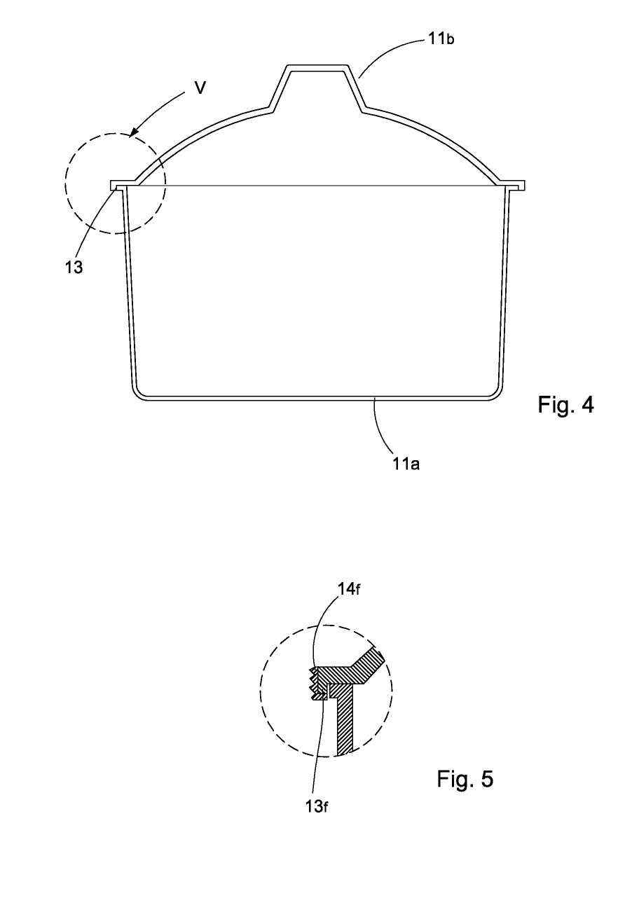

In the construction variant of FIGS. 4 and 5, the edge 13f is constructed on the lid 11b. The seal 14f which is applied to the edge 13f is of the type having multiple lips, similar to the seal 14a. Generally, however, any one of the other seals 13b-e described above for the variants with an edge 13 on the bowl 11a, could also be advantageously applied to the edge 13f.

As an alternative to the fixing by being jointly injection-moulded, there is provision for the seals to be able to be applied by thermal sealing, adhesive-bonding or other similar technologies.

By adoption of the above-indicated seals which are applied in addition to the external edge, it is possible to construct cartridges which are adaptable to seats which have a shape which does not completely engage with that of the edge, benefiting from the ease of resilient deformability of the seal. It is thereby possible to substantially compensate for dimensional and/or structural tolerances which otherwise inhibit the sealing insertion of the filter in the seat by means of radial compression of the seal in the gap between the edge and the seat when the cartridge is fitted in the seat.

1. A replaceable cartridge type filter for filtering systems comprising a casing for containing the filtering material which extends externally from an annular edge which defines a sealing surface, which is provided to engage in a sealing manner with a corresponding seat for receiving and retaining the cartridge so as to identify an upstream portion and a downstream portion with respect to the cartridge which communicate with each other only by way of the cartridge, wherein the filter comprises, at the annular edge, a deformable seal whose deformability under load is substantially greater than the deformability of the edge.

2. The filter according to claim 1, wherein the seal is fixed in a non-movable manner to the annular edge.

3. The filter according to claim 2, wherein the seal is fixed to the annular edge by means of joint injection-moulding with the casing of the cartridge.

4. The filter according to claim 1, wherein the seal is of a type having a lip.

5. The filter according to claim 4, wherein the seal has a profile with multiple lips.

6. The filter according to claim 1, wherein there are provided at least two axial seals at the edge.

7. The filter according to claim 1, wherein the filtering system is a filtering system for processing drinking water.

8. A filtering system comprising a pipe, in which there is defined a seat for receiving in a sealing manner a replaceable cartridge which is constructed in accordance with claim 1.

9. The filtering system according to claim 8, wherein a connection of the edge and a facing wall of the seat is brought about with play, the seal being compressed in a gap between the edge and the seat when the cartridge is fitted in the seat.

10. The filtering system according to claim 8, wherein the facing wall of the seat has a plurality of projecting rib structures.

11. The filtering system according to claim 9, wherein the facing wall of the seat has a plurality of projecting rib structures.
